(19) United States
(12) Patent Application Publication
(10) Pub. No.: US 2008/0189623 A1
(43) Pub. Date: Aug. 7, 2008

(54) METHOD AND SYSTEM FOR ENHANCING COMMUNICATION WITH INSTANT MESSENGER/CHAT COMPUTER SOFTWARE APPLICATIONS

(75) Inventor: Sandeep Ramesh Patil, Pune (IN)

Correspondence Address: GERALD J. IWANEJKO, JR., 229 HICKORY HILL DRIVE, VOLANT, PA, 16156, US

(73) Assignee: INTERNATIONAL BUSINESS MACHINES CORPORATION, Armonk, NY (US)

(21) Appl. No.: 11/671,183

(22) Filed: Feb. 5, 2007

(51) Int. Cl. G06F 3/00

(52) U.S. Cl. 715/753

(57) ABSTRACT

An invention is disclosed for providing instant messaging (IM)/chat computer software applications with an automatic secondary “pop-up window” feature that is optionally enabled by a communicating user to cause a separate dialog box window (i.e., a “child window”) to appear for every query or question asked (or other user input received) in a “question and answer” or other IM/chat communication session, in order to individually display each question (or other user input) along with a text entry area for providing an answer or other response.

### TECHNICAL FIELD

This invention relates to communication with instant messenger (IM)/chat computer software applications.

### BACKGROUND

“Chat” or “instant messenger” (IM) software applications (such as Yahoo Instant Messenger®, MSN Messenger®, IBM Sametime® etc.) have become a primary mode of communication between computer users to allow instantaneous (or “real-time) conversation between them over networked mediums such as the Internet. IM/chat applications can often accommodate a wide range of uses ranging from corporate/business purposes to product support applications to personal and/or entertainment uses. However, current technology exhibits significant disadvantages relating to communications involving “question-and-answer” sessions between users.

Current IM/chat applications allow one or more communicating part(ies) to send multiple queries or questions in real-time succession to other parties involved in the chat/IM communication, with one or more other part(ies) typically responding to one, some or all of those queries. However, ambiguity can be created with current IM/chat systems under these circumstances, since there is no direct matching or correlation (i.e, “mapping”) of a particular answer to the query or question to which it responds. This lack of “mapping” can cause uncertainty and confusion as to which question or query a particular answer applies, when a reply is delayed in time by the responding party instead of being provided in immediate or synchronized succession to the question, since the IM/chat application software is not provided with control over synchronizing the timing of response(s) to a given question or query being asked in a “question-and answer” session. There is no technology implemented by existing IM/chat (including chatbot) applications to solve this problem, as it is left to the users to synchronize their communication instead of providing system feature(s) to automatically address the problem.

### SUMMARY OF THE INVENTION

An invention is disclosed for enhancing communication with instant messaging (IM) or chat computer software applications. Specifically, a method and system is provided for using IM/chat software applications having an automatic secondary “pop-up window” feature, that is optionally enabled by a communicating user to cause a separate dialog box window (i.e., a “child window”) to appear for every query or question asked (or other user input sent and received) in a “question and answer” or other IM/chat communication session, in order to individually display each question (or other user input) along with a text entry area for providing an answer or other response. This feature requires the answering party to respond to only the particular question appearing in a given “child window”, whereupon transmission of the reply will cause the answer provided in the “child window” to appear in the primary IM/chat (or “parent”) window paired in combination with the question to which it responds, at which point the pop-up “child window” disappears. This feature permits the matching (or “mapping”) of one or more answer(s) or other response(s) to each query or question asked (or other input sent and/or received) by a computer user in an IM/chat system “question and answer” or other communication session, in order to eliminate ambiguity and improve system performance.

It is therefore an object of the present invention to overcome the disadvantages of the prior art by enhancing communication with instant messenger (IM)/chat computer software applications through matching (or “mapping”) of responses to each input sent and/or received by a computer user in an IM/chat system communication session, in order to eliminate ambiguity and improve system performance.

It is another object of the present invention to overcome the disadvantages of the prior art by providing a method and system for using IM/chat computer software applications having an automatic secondary “pop-up window” feature that is optionally enabled by a communicating user to cause a separate dialog box window to appear for every user input sent and received in an IM/chat communication session, in order to individually display each user input along with an entry area for providing a response.

The subject matter which is regarded as the invention is particularly pointed out and distinctly claimed in the concluding portion of the specification. The invention, however, together with further objects and advantages thereof, may best be understood by reference to the following description taken in conjunction with the accompanying drawings.

### BRIEF DESCRIPTION OF THE DETAILED DRAWINGS

FIG. 1 illustrates communication with a prior art instant messenger (IM)/chat computer software application.

FIG. 2 illustrates a preferred computer program algorithm for communication with an IM/chat software application of the invention.

FIG. 3 illustrates communication between a sender and receiver using a “parent window” and a “child window” in the IM/chat software application of the invention.

FIG. 4 illustrates a “parent window” after completion of a communication between a sender and receiver using the IM/chat software application of the invention.

### DETAILED DESCRIPTION OF THE PREFERRED EMBODIMENTS

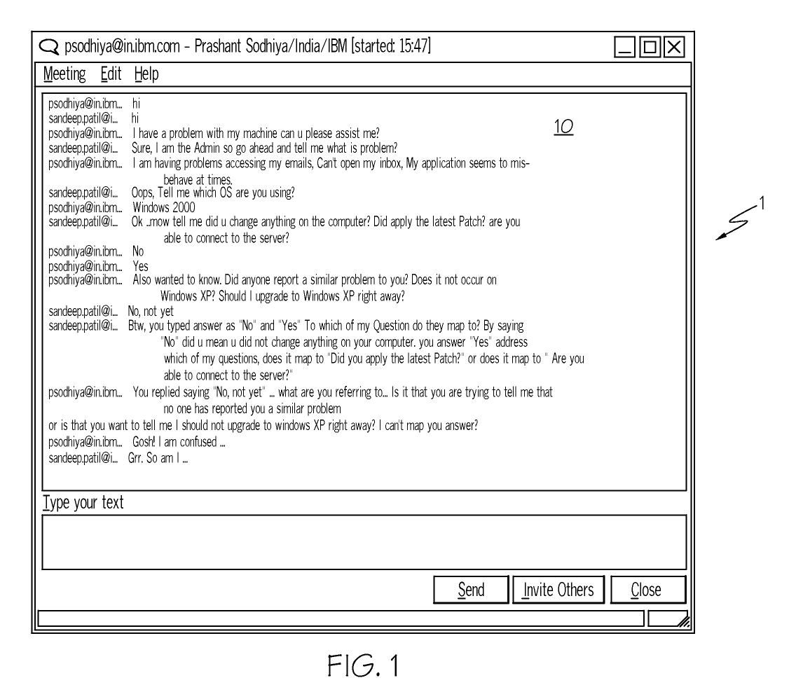

FIG.1 illustrates a common scenario arising in a chat or instant messaging (IM) “question-and answer” session involving communication between a computer system administrator and a user who has encountered a problem for which diagnostic help is sought from the administrator using the IM/chat application. As can be seen from this illustration, ambiguity and confusion arises from a lack of direct matching or correlation (i.e, “mapping”) of a particular answer to the query or question to which it responds.

The invention provides an algorithm that can be preferably implemented in any commonly-used object-oriented computer programming language (such as Java® or C++) to synchronize the matching (or “mapping”) of an answer (or other response) to each query or question asked (or other user input sent and received) in an IM/chat system “question and answer” or other type of communication session such as that illustrated in FIG.1. The algorithm operates under the assumption that two or more users are simultaneously communicating via any standard computer chat or IM system application 1 such as Yahoo Instant Messenger®, MSN Messenger®, IBM Sametime® etc. (including those providing a ChatBot capability) which can operate over a network (such as the Internet) using a Microsoft Windows® (or similar) graphical user interface (GUI); including the systems disclosed in U.S. Patent Application Publication Nos. US20050050143A1 & US20050149621A1 (which are both incorporated by reference as if fully set forth herein). The algorithm also assumes that the user software or (“client end”) of the IM/chat application is capable of being operated in a “multi-threaded” manner (i.e., can simultaneously accommodate multiple user inputs in accomplishing different processing tasks). The algorithm additionally assumes that if a sentence (or a group of words or lines) to be communicated in an IM/chat session is followed by a designated character (such as “?”) then the entire text content input prior to the “?” character (including the “?” character) forms the query or question to be answered. (Another way to map a user input with its response is to scan through the content displayed on the main chat “parent window(s)” 10 of both the sender and receiver by searching for the input sent and received whether or not it is delineated by a “?” character.)

The algorithm can preferably be applied to use of “modal” dialog box “child windows” 20; i.e., a “modal” dialog “child window” will not allow a user to access the main IM/chat “parent window” 10 once invoked, whereas a “modaless” dialog window permits a user to work within the “parent window” 10 (or use other application features) while the “child window” 20 is still active. (With a “modal” dialog window, a user cannot enter inputs in any other dialog box or invoke another menu option within the application without explicitly closing the “modal” dialog box.) An application user optionally selects (i.e., activates or enables) or inactivates (disables or de-selects) the “pop-up” secondary “child window” feature 20 to operate in “modal” configuration through use of an application checkbox or a menu option.

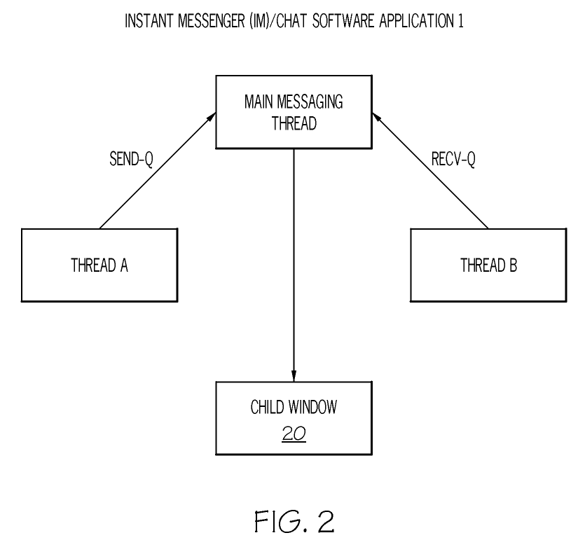

As illustrated in FIG. 2, the algorithm model is implemented by initiating and executing operation of the following program components if the “child window” feature 20 has been selected by the user; otherwise the standard default behavior of the IM/chat application is invoked. In the example of a “question and answer” session, Thread A continuously scans the text characters entered by a querying user (such as for example in the “type-your-text” edit section of the IBM Lotus Notes Sametime Connect® chat window) in order to signal a system event object SEND-Q to the Main Messaging Thread as soon as the “?” character is encountered. (When the querying user types the “?” character, the Main Messaging Thread receives a SEND-Q object signal from Thread A and it then sends the query message to the other receiving part(ies), This ensures that the querying user preferably cannot enter multiple questions at a single time in order to eliminate confusion and ambiguity.) Thread B continuously scans text content (character by character) received by another party from a querying user in order to signal an event object RECV-Q to the Main Messaging Thread as soon as the “?” character is encountered by the receiver(s). (As soon as a recipient receives a query, the Main Messaging Thread belonging to the IM/chat application of the receiver obtains a RECV-Q object signal from Thread B, indicating that a modal dialog box (with the question) should be “popped-up” to allow the recipient to answer the question contained therein. (Thread A along with Thread B and the Main Messaging Thread are preferably contained within the IM/chat application used by all communicating parties.) The Main Messaging Thread controls the operation of Thread A & Thread B by handling the processing of a signaled SEND-Q event in coordination with any RECV-Q event in order to synchronize their execution.

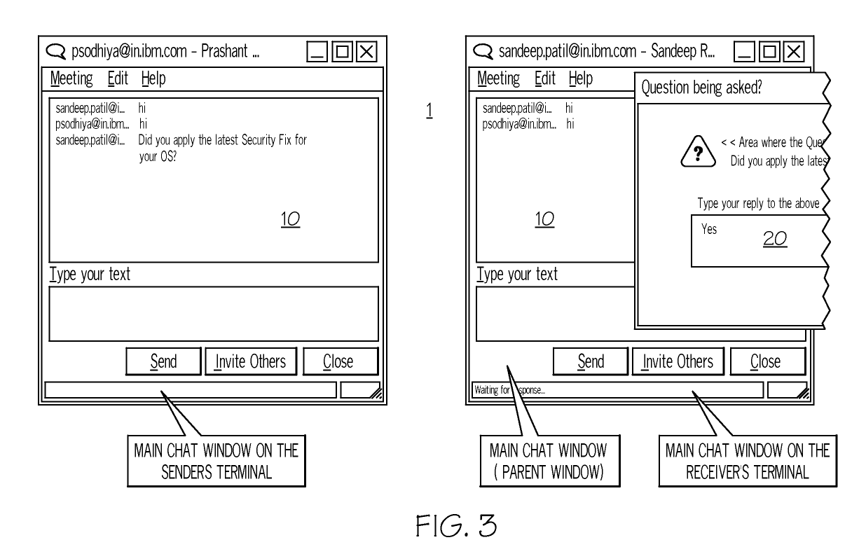

FIG. 3 shows corresponding IM/chat primary user interface display “parent windows” 10 for both a sender and a receiver when a query or question is initiated by the sender, in order to illustrate a secondary “modal” dialog box (or “child window”) 20 that is activated (or “popped up”) in the user interface display when the receiver encounters a query (or other input) from the sender. In the example of a “question and answer” session, when the Main Messaging Thread is signaled with a SEND-Q event indicating that Thread A has encountered a “?” character from a querying user, then all of the text content entered prior to (and including) the “?” character is sent to all of the other part(ies) involved in the IM/chat communication by executing the SEND-Q event. When the Main Messaging Thread is signaled with a RECV-Q event, it indicates that Thread B has encountered the “?” character and that the entire text content input prior to (and including) the “?” character forms the query or question to be answered in reply by one or more receiving part(ies). Upon execution of the RECV-Q event, the Main Messaging Thread then creates a new “child window” 20 with the main IM/chat window acting as the “parent window” 10. The “child window” 20 contains the question to be answered along with an editable text area for the responding user to enter a reply.

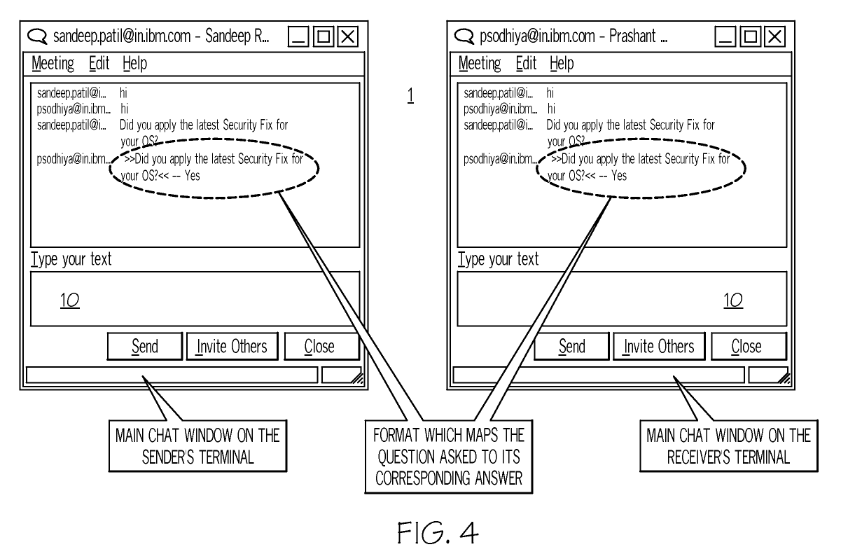

FIG. 4 illustrates the state of “parent window(s)” 10 of the sender and receiver(s) after the receiver has replied to the sender query. Transmission of a reply to the question or query causes the “child window” 20 previously displayed to the receiver to disappear and transfers program control to the primary IM/chat “parent window” 10. As illustrated in FIG. 4, the “parent window” 10 of both the sender and receiver displays the question (or other user input) and its corresponding answer(s) or other response(s) paired together in a particular desired format (such as by use of unique highlighting characters and/or colors and fonts) to provide one-to-one “mapping” identifying a question/input with its matching answer(s)/response(s).

While certain preferred features of the invention have been shown by way of illustration, many modifications and changes can be made that fall within the true spirit of the invention as embodied in the following claims, which are to be interpreted as broadly as the law permits to cover the full scope of the invention, including all equivalents thereto.

What is claimed is:

1. A computer system for conducting instant message or chat communications between two or more users and comprised of at least the following software program components:
(a). a primary user interface located at a sending and receiving user for displaying a user input combined with one or more corresponding response(s); and
(b). an optionally enabled secondary user interface that automatically appears for creating a separate response to each user input sent and received in a communication session by individually displaying a user input along with an area for entering the response;
wherein each user input is paired with a matching response for display together in a desired format during an instant message or chat system communication session.

2. The computer system of claim 1 wherein the secondary user interface disappears and a user input is displayed together with a matching response in the primary user interface upon transmission of the response.

3. The computer system of claim 1 further comprised of at least the following program components for enabling the secondary user interface:
(a). a first program component for scanning characters entered by a sending user to signal a system send event when a designated character is encountered;
(b). a second program component for scanning characters received from a sending user to signal a system receive event when the designated character is encountered by a receiving user;
(c). a third program component for controlling operation of the first and second program components to handle processing of a signaled send event in coordination with its corresponding receive event;
wherein all characters entered prior to the designated character are sent for display in the secondary user interface of the receiving users involved in the communication session upon execution of a receive event.

4. The computer system of claim 3 wherein the designated character is a “?” character.

5. The computer system of claim 1 wherein two or more users are simultaneously communicating over a network using an instant message or chat system application having a graphical user interface.

6. The computer system of claim 5 wherein the secondary user interface is comprised of a modal dialog box window.

7. The computer system of claim 5 wherein the instant message or chat system application provides a ChatBot capability.

8. The computer system of claim 1 wherein the instant message or chat communication comprises a question and answer session.

9. A method of using a computer system for conducting instant message or chat communications between two or more users and comprised of at least the following steps carried out by the following software program components:
(a). using a primary user interface located at a sending and receiving user for displaying a user input combined with one or more corresponding response(s); and
(b). optionally enabling a secondary user interface that automatically appears for creating a separate response to each user input sent and received in a communication session by individually displaying a user input along with an area for entering the response;
wherein each user input is paired with a matching response for display together in a desired format during an instant message or chat system communication session.

10. The method of claim 9 wherein the secondary user interface disappears and a user input is displayed together with a matching response in the primary user interface upon transmission of the response.

11. The method of claim 9 further comprised of at least the following steps carried out by the following program components for enabling the secondary user interface:
(a). using a first program component for scanning characters entered by a sending user to signal a system send event when a designated character is encountered;
(b). using a second program component for scanning characters received from a sending user to signal a system receive event when the designated character is encountered by a receiving user;
(c). using a third program component for controlling operation of the first and second program components to handle processing of a signaled send event in coordination with its corresponding receive event;
wherein all characters entered prior to the designated character are sent for display in the secondary user interface of the receiving users involved in the communication session upon execution of the receive event.

12. The method of claim 11 wherein the designated character is a “?” character.

13. The method of claim 9 wherein two or more users are simultaneously communicating over a network using an instant message or chat system application having a graphical user interface.

14. The method of claim 13 wherein the secondary user interface is comprised of a modal dialog box window.

15. The method of claim 13 wherein the instant message or chat system application provides a ChatBot capability.

16. The method of claim 9 wherein the instant message or chat communication comprises a question and answer session.
